(19) United States
(12) Patent Application Publication
(10) Pub. No.: US 2021/0274813 A1
(43) Pub. Date: Sep. 9, 2021

(54) POLYPHENOL-RICH AND LOW-SUGAR BEVERAGE OF FERMENTED JUJUBE PULP AND PREPARATION METHOD THEREOF

(71) Applicant: CHINA AGRICULTURAL UNIVERSITY, Beijing (CN)

(72) Inventors: Jihong WU, Beijing (CN); Jing LI, Beijing (CN); Fei LAO, Beijing (CN); Xiaosong HU, Beijing (CN); Yue WU, Beijing (CN); Xin PAN, Beijing (CN)

(21) Appl. No.: 17/330,440

(22) Filed: May 26, 2021

Related U.S. Application Data
(63) Continuation of application No. PCT/CN2020/132356, filed on Nov. 27, 2020.

(30) Foreign Application Priority Data
Feb. 7, 2020 (CN) 202010082452.4

(51) Int. Cl. A23L 2/38; A23L 2/04; A23L 3/015

(52) U.S. Cl. CPC A23L 2/382; A23Y 2240/75; A23L 3/0155; A23L 2/04

(57) ABSTRACT

Provided are a polyphenol-rich and low-sugar beverage of fermented jujube pulp and a preparation method thereof. The fermented jujube pulp beverage is prepared with a method including the following steps: (1) selecting jujubes that are free of rot and are not insect-eaten, rinsing with pure water, pre-boiling in boiling water, and removing cores; (2) beating the jujubes whose cores are removed in step (1) into a beating machine to obtain a jujube pulp; (3) pouring the jujube pulp in step (2) into a colloid mill for processing to refine jujube peels to obtain a refined jujube pulp; (4) subjecting the refined jujube pulp to ultra-high-pressure sterilization; and (5) inoculating Streptococcus thermophilus into the jujube pulp after the sterilization in step (4), and performing a fermentation cultivation to obtain a fermented jujube pulp.

### CROSS-REFERENCE TO RELATED APPLICATIONS

This application is a continuation of International Application No. PCT/CN2020/132356, filed on Nov. 27, 2020, which claims priority to Chinese Patent Application No. 202010082452.4, filed on Feb. 7, 2020, the entire contents of which are incorporated herein by reference.

### TECHNICAL FIELD

The present disclosure belongs to the technical field of fermented fruit juices, and particularly, to a polyphenol-rich and low-sugar beverage of fermented jujube pulp, and a preparation method thereof.

### BACKGROUND

Jujube, due to their high nutritional, medicinal, and health-care effects, is a source natural medicinal and edible food and a unique functional food resource in China. The processing and utilization of jujubes has a long history, and the fresh jujubes are mainly processed into dried jujubes to preserve the fruits. With the in-depth research on the nutritional and functional components of jujubes and the continuous improvement of post-harvest processing technology, the deep processing of jujubes attracts more attentions, leading to a trend of diversification and deepening of the entire industry. However, the jujubes have a relatively high sugar content, and the sugar content per 100 grams of dried jujubes can reach about 60% or more. Excessive sugar intake may induce obesity, cause “metabolic syndrome”, and increase the risk of hypertension, diabetes, arthrolithiasis, and other diseases. Therefore, a deep-processed jujube product with a low sugar content is desired.

### SUMMARY

An object of the present disclosure is to provide a polyphenol-rich and low-sugar beverage of fermented jujube pulp.

The present disclosure provides a polyphenol-rich and low-sugar beverage of fermented jujube pulp through screening strains of lactobacillus (Lactobacillus plantarum, Streptococcus thermophilus, and Leuconostoc mesenteroides) and through determining the most suitable strain based on the sugar content and total phenol content of the jujube pulp. In such a product, the sugar content of the jujube beverage is reduced while increasing the total phenol content, thereby improving the nutritional value, and broadening the range of applicable population.

The polyphenol-rich and low-sugar beverage of fermented jujube pulp provided by the present disclosure is prepared according to a method including the following steps:

step 1 of selecting jujubes that are free of rot and are not insect-eaten, rinsing with pure water, pre-boiling in boiling water, and removing cores;

step 2 of beating the jujubes whose cores are removed in step 1 into a beating machine to obtain a jujube pulp;

step 3 of pouring the jujube pulp obtained in step 2 into a colloid mill for processing to refine jujube peels to obtain a refined jujube pulp;

step 4 of subjecting the refined jujube pulp to an ultra-high-pressure sterilization; and

step 5 of inoculating Streptococcus thermophilus into the jujube pulp after the sterilization in step 4, and performing a fermentation cultivation to obtain a fermented jujube pulp.

In step 1 of the method, species of the jujubes may be Ziziphus Jujuba cv. Jinsixiaozao, Huizao and Huanghetan. The pre-boiling may last for 5 minutes to 10 minutes.

In step 2 of the method, a mass ratio of the jujube whose cores are removed to water may be (2-6):(5-10), and specifically may be 3:5, 2:7, etc.

In step 3 of the method, a cycling time for the processing in the colloid mill may be 10 to 15 minutes.

In step 4 of the method, the ultra-high-pressure sterilization can be conducted under 550 to 600 MPa for 10 minutes.

In step 5 of the method, the Streptococcus thermophilus can specifically

Streptococcus thermophilus CICC 6220; the cultivation can be performed at 35 to 37° C. (specifically 37° C.) with shaking for 40 to 56 hours (specifically, 40 h, 48 h, or 56 h). The Streptococcus thermophilus can be added in a form of a bacterial solution, and an amount of the added bacterial solution can range from 4% to 5% of a volume of the jujube pulp (specifically, 4%, 4.5%, or 5%). A concentration of the Streptococcus thermophilus in the bacterial solution can be 7.25±0.03 cfu/ml.

The method further includes steps of activating and purifying strains of Streptococcus thermophilus before the inoculation, which are specifically described as below.

Streptococcus thermophilus is inoculated into a sterilized MRS liquid medium, and cultured at 37° C. for 24 h. An appropriate amount of the bacterial solution is picked with an inoculating loop, spread on an MRS solid medium, and cultured at 37° C. for 24 h. 2-3 individual colonies are selected and inoculated to the MRS liquid medium again, and cultured at 37° C. for 24 hours to obtain an activated bacterial solution to be inoculated into the jujube pulp.

In embodiments of the present disclosure, a pH value of the jujube pulp is reduced to 3.6-3.4 after the fermentation.

The fermented jujube pulp prepared by the method also falls within the protection scope of the present disclosure.

Compared with the prior art, the present disclosure has the following advantages. In the present disclosure, the Streptococcus thermophilus is adopted as the fermentation bacterial strain to obtain the polyphenol-rich and low-sugar jujube pulp after the fermentation. No exogenous sugar is added in the product, and the endogenous sugar in the jujubes serves as a carbon source for the growth of the lactic acid bacteria. The total sugar content of the final fermented jujube pulp ranges from 0 13.48 to 14.6 g/100 g, reduced by 4% to 11%; the reduced sugar content ranges from 10.51 to 11.52 g/100 g, reduced by 5%-14%. Meanwhile, the fermentation with lactic acid bacteria can promote the release of polyphenols in the jujube peels, and the total phenol content increases from 7.21 mg/g before the fermentation to 7.86-8.66 mg/g after the fermentation.

The present disclosure develops a polyphenol-rich and low-sugar beverage of fermented jujube pulp by using the fermentation characteristics of lactic acid bacteria without adding any exogenous sugar. In this way, the total sugar and the reducing sugar are reduced while increasing the total phenol content of the product, thereby greatly improving the nutritional value of the jujube beverage. The product is suitable for all kinds of people.

### BRIEF DESCRIPTION OF DRAWINGS

The above-mentioned and/or additional aspects and advantages of the present disclosure will become apparent and understandable from the description of the embodiments in conjunction with the following drawings, in which:

FIG. 1 is a diagram illustrating a comparison of changes in total phenol contents of the jujube pulp product prepared in Example 2, the unfermented jujube pulp, and jujube pulp controls fermented by two types of lactic acid bacteria, Lactobacillus plantarum and Leuconostoc mesenteroides.

### DESCRIPTION OF EMBODIMENTS

The present disclosure is described below through specific embodiments, but the present disclosure is not limited thereto. Any modifications, equivalent replacements and improvements made within the spirit and principle of the present disclosure shall be included in the protection scope of the present disclosure.

The experimental methods used in the following examples are all conventional methods unless otherwise specified.

The materials and reagents used in the following examples can be obtained from commercial sources unless otherwise specified.

The quantitative tests in the following examples are each repeated for three times, and the results are expressed as mean±standard deviation.

In the following examples, the method for measuring the reducing sugar content and the total sugar content in beverages of fermented jujube pulp is the 3,5-dinitrosalicylic acid (DNS) method; and the method for measuring the total phenol content is a total phenol (TP) content detection kit.

Three bacterial strains used in the following examples:

Streptococcus thermophilus: CICC 6220;

Lactobacillus plantarum: CICC 20265; and

Leuconostoc mesenteroides: CICC 21859.

The above bacterial strains were purchased from China Center of Industrial Culture Collection (CICC).

The Ziziphus Jujuba cv. Jinsixiaozao used in the following examples is Ziziphus jujuba produced in Laoling, Shandong province.

### Example 1. Preparation of Polyphenol-Rich and Low-Sugar Beverage of Fermented Jujube Pulp

1. Ziziphus jujuba that was free of rot and was not insect-eaten was selected, rinsed with pure water, pre-boiled for 10 minutes, and the cores were removed. The contents of active nutrients of. Ziziphus jujuba are shown in Table 1.

2. The jujubes whose cores had been removed in step 1 were put into a beating machine and beaten according to a ratio of jujube:water=3:5 (m/m) to obtain a jujube pulp.

3. The jujube pulp in step 2 was poured into a colloid mill and cycled for 10 minutes to refine the jujube peels.

4. The refined jujube pulp was put into an ultra-high-pressure vial for ultra-high-pressure sterilization at 600 MPa for 10 minutes.

5. Activation and purification of bacterial strains: Streptococcus thermophilus was inoculated into a sterilized MRS liquid medium, and incubated at 37° C. for 24 hours. An appropriate amount of bacterial solution was picked with an inoculating loop, spread on an MRS solid medium, and incubated at 37° C. for 24 hours. 2 individual colonies were picked and inoculated to an MRS liquid medium again, incubated at 37° C. for 24 hours, for later use.

6. The activated bacterial solution (in which the concentration of Streptococcus thermophilus was 7.25±0.03 cfu/ml) was added to the jujube pulp in step 4 at a volume ratio of 4%, and incubated under shaking at 37° C. for 56 hours to obtain a fermented jujube pulp. In the fermented jujube pulp, the content of reducing sugar was 10.51±0.25 g/100 g, the content of total sugar was 13.48±0.17 g/100 g, and the content of total phenol was 7.86±0.09 mg GAE/g.

### Example 2. Preparation of Polyphenol-Rich and Low-Sugar Beverage of Fermented Jujube Pulp

1. Ziziphus jujuba that was free of rot and not insect-eaten was selected, rinsed with pure water, pre-boiled for 10 minutes, and the cores were removed.

2. The jujubes whose cores had been removed in step 1 were put into a beating machine and beaten according to a ratio of jujube:water=3:5 (m/m) to obtain a jujube pulp.

3. The jujube pulp in step 2 was poured into a colloid mill and cycled for 10 minutes to refine the jujube peels.

4. The refined jujube pulp was put into an ultra-high-pressure vial for ultra-high-pressure sterilization at 550 MPa for 10 minutes.

5. Activation and purification of bacterial strains: Streptococcus thermophilus was inoculated into a sterilized MRS liquid medium, and incubated at 37° C. for 24 hours. An appropriate amount of bacterial solution was picked with an inoculating loop, spread on an MRS solid medium, and incubated at 37° C. for 24 hours. 2 individual colonies were picked and inoculated to an MRS liquid medium again, incubated at 37° C. for 24 hours, for later use.

6. The activated bacterial solution (in which the concentration of Streptococcus thermophilus was 7.25±0.03 cfu/ml) was added to the jujube pulp in step 4 at a volume ratio of 4.5%, and incubated under shaking at 37° C. for 48 hours to obtain a fermented jujube pulp. The contents of reducing sugar and total sugar in the fermented jujube pulp are shown in Table 2; and the content of total phenols is 8.66±0.12 mg GAE/g.

TABLE 1
Active nutrient contents of raw Jinsixiaozao

| | Total | Total | | | | | |
|---|---|---|---|---|---|---|---|
| | phenols/ | flavonoids/ | | Triterpenic acid/ | | | |
| | mg | mg | VC/ | mg · (100 g DW)⁻¹ | | | α-Tocopherol/ |
| | GA · (100 g | RE · (100 g | mg · (100 | Betulinic | Oleanolic | Ursolic | mg · (kg |
| Species | FW)⁻¹ | FW)⁻¹ | g FW)⁻¹ | acid | acid | acid | DW)⁻¹ |
| Jinsixiaozao | 525.40 ± | 373.11 ± | 380.26 ± | 44.74 ± | 35.81 ± | 21.98 ± | 1.18 0.18 |
| | 22.37 | 21.62 | 9.50 | 4.34 | 3.81 | 1.72 | |

### Comparative Example 1. Preparation of beverage of unfermented jujube pulp

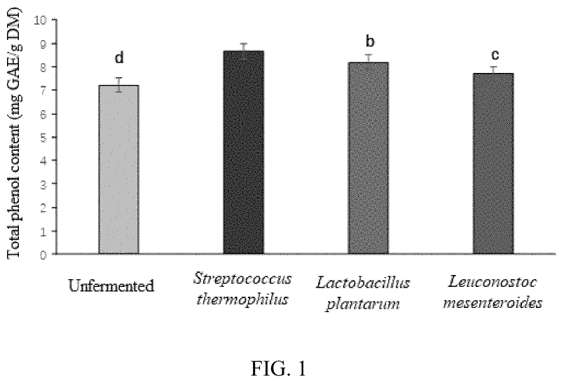

Preparation was conducted according to step 1) to step 4) in Example 2. The contents of reducing sugar and total sugar in the jujube pulp are shown in Table 2, which are significantly different from those of the jujube pulp fermented by “Streptococcus thermophilus”. The total phenol content is shown in FIG. 1, which is 7.21±0.09 mg GAE/g and is significantly different from that of the jujube pulp fermented by “Streptococcus thermophilus”.

### Comparative Example 2. Preparation of Beverage of Fermented Jujube Pulp Fermented with “Lactobacillus plantarum”

The method is basically the same as that in Example 2, except that the “Streptococcus thermophilus” in Example 2 was replaced with “Lactobacillus plantarum”. The contents of reducing sugar and total sugar in the fermented jujube pulp are shown in Table 2, which are not significantly different from those of the jujube pulp fermented by “Streptococcus thermophilus”. The total phenol content is shown in FIG. 1, which is 8.20±0.14 mg GAE/g and significantly different from that of the jujube pulp fermented by “Streptococcus thermophilus”.

### Comparative Example 3. Preparation of Beverage of Fermented Jujube Pulp Fermented with “Leuconostoc mesenteroides”

The method is basically the same as that in Example 2, except that the “Streptococcus thermophilus” in Example 2 was replaced with “Leuconostoc mesenteroides”. The contents of reducing sugar and total sugar in the fermented jujube pulp are shown in Table 2, which are not significantly different from those of the jujube pulp fermented by “Streptococcus thermophilus”. The content of total phenols is shown in FIG. 1, which is 7.71±0.1 mg GAE/g and is significantly different from that of the jujube pulp fermented by “Streptococcus thermophilus”.

TABLE 2
Comparison of sugar content before and after 48 h of fermentation

| | | Streptococcus | Lactobacillus | Leuconostoc |
|---|---|---|---|---|
| | Unfermented | thermophilus | plantarum | mesenteroides |
| Reducing sugar (g/100 g) | 12.16 ± 0.63^{a} | 11.18 ± 0.15 | 11.23 ± 0.31^{b} | 11.19 ± 0.22^{b} |
| Total sugar (g/100 g) | 15.29 ± 0.14^{a} | 14.4 ± 0.08 | 14.55 ± 0.78^{b} | 15.2 ± 0.27^{b} |

### Example 3. Preparation of Polyphenol-Rich and Low-Sugar Beverage of Fermented Jujube Pulp

1. Ziziphus jujuba that was free of rot and not insect-eaten was selected, rinsed with pure water, pre-boiled for 5 minutes, and the cores were removed.

2. The dates whose cores had been removed in step 1 were put into a beating machine and beaten according to a ratio of date:water=3:5 (m/m) to obtain a jujube pulp.

3. The jujube pulp in step 2 was poured into a colloid mill and cycled for 10 minutes to refine the jujube peels.

4. The refined jujube pulp was put into an ultra-high-pressure vial for ultra-high-pressure sterilization at 600 MPa for 10 minutes.

5. Activation and purification of bacterial strains: Streptococcus thermophilus was inoculated into a sterilized MRS liquid medium, and incubated at 37° C. for 24 hours. An appropriate amount of bacterial solution was picked with an inoculating loop, spread on an MRS solid medium, and incubated at 37° C. for 24 hours. 3 individual colonies were picked and inoculated in an MRS liquid medium again, incubated at 37° C. for 24 hours, for later use.

6. The activated bacterial solution (in which the concentration of Streptococcus thermophilus was 7.25±0.03 cfu/ml) was added to the jujube pulp in step 4 at a volume ratio of 5%, and incubated under shaking at 37° C. for 40 hours to obtain a fermented jujube pulp.

In the fermented jujube pulp, the content of reducing sugar was 11.52±0.21 g/100 g, the content of total sugar was 14.6±0.18 g/100 g, and the total phenol content was 8.47±0.12 mg GAE/g.

In the present disclosure, the expressions “one embodiment”, “some embodiments”, “examples”, “specific examples”, “some examples”, etc. mean that the specific features, structures, materials, or characteristics described in conjunction with the embodiment or example are included in at least one embodiment or example of the present disclosure. In this specification, the above terms do not necessarily refer to the same embodiment or example. Moreover, the specifically described features, structures, materials or characteristics can be combined in any one or more embodiments or examples in a suitable manner. In addition, those skilled in the art can combine the different embodiments or examples and the features of the different embodiments or examples described in this specification without contradicting each other.

Although the embodiments of the present disclosure have been shown and described above, it can be understood that the above-mentioned embodiments are exemplary and should not be construed as limitations of the present disclosure. Those skilled in the art can make changes, modifications, replacements and modifications to the above-mentioned embodiments without departing from the scope of the present disclosure.

What is claimed is:

1. A preparation method of a polyphenol-rich and low-sugar beverage of fermented jujube pulp, the preparation method comprising:
step 1 of selecting jujubes that are free of rot and are not insect-eaten, rinsing with pure water, pre-boiling in boiling water, and removing cores;
step 2 of beating the jujubes whose cores are removed in step 1 into a beating machine to obtain a jujube pulp;
step 3 of pouring the jujube pulp obtained in step 2 into a colloid mill for processing to refine jujube peels to obtain a refined jujube pulp;
step 4 of subjecting the refined jujube pulp to an ultra-high-pressure sterilization; and
step 5 of inoculating Streptococcus thermophilus into the jujube pulp after the sterilization in step 4, and performing a fermentation cultivation to obtain a fermented jujube pulp.

2. The preparation method according to claim 1, wherein in step 1, species of the jujube is Ziziphus Jujuba cv. Jinsixiaozao, Huizao and Huanghetan; and the pre-boiling lasts for 5 minutes to 10 minutes.

3. The preparation method according to claim 1, wherein in step 2, a mass ratio of the dates whose cores are removed to water is (2 to 6):(5 to 10).

4. The preparation method according to claim 1, wherein in step 3, a cycling time for the processing in the colloid mill is 10 minutes to 15 minutes.

5. The preparation method according to claim 1, wherein in step 4, the ultra-high-pressure sterilization is performed at 550 MPa to 600 MPa for 10 minutes.

6. The preparation method according to claim 1, wherein in step 5, the fermentation cultivation is performed at 35° C. to 37° C. with shaking for 40 hours to 56 hours.

7. The preparation method according to claim 1, wherein the Streptococcus thermophilus is added in a form of a bacterial solution, and a concentration of the Streptococcus thermophilus in the bacterial solution is 7.25±0.03 cfu/ml; and an amount of the added bacterial solution is 4% to 5% of a volume of the jujube pulp.

8. A polyphenol-rich and low-sugar beverage of fermented jujube pulp prepared by the preparation method according to claim 1.

9. The polyphenol-rich and low-sugar beverage of fermented jujube pulp according to claim 8, wherein, per 100 g of the fermented jujube pulp, a content of total sugar ranges from 13.48 g to 14.6 g, a content of reducing sugar ranges from 10.51 g to 11.52 g, and a content of total phenols ranges from 7.86 mg/g to 8.66 mg/g.
